(19) United States
(12) Patent Application Publication
(10) Pub. No.: US 2019/0102515 A1
(43) Pub. Date: Apr. 4, 2019

(54) METHOD AND DEVICE FOR DECODING DATA SEGMENTS DERIVED FROM OLIGONUCLEOTIDES AND RELATED SEQUENCER

(71) Applicant: Thomson Licensing, Issy-les-Moulineaux (FR)

(72) Inventors: Xiaoming Chen, Hannover (DE); Meinolf Blawat, Hannover (DE); Klaus Gaedke, Hannover (DE); Ingo Huetter, Pattensen (DE)

(21) Appl. No.: 16/082,951

(22) PCT Filed: Mar. 6, 2017
(86) PCT No.: PCT/EP2017/055213

§ 371 Date: Sep. 7, 2018

(30) Foreign Application Priority Data
Mar. 8, 2016 (EP) 16305262.4

(51) Int. Cl. G16B 30/10

(52) U.S. Cl. CPC G06F 19/22; G06F 19/24

(57) ABSTRACT

Data segments derived from stored oligonucleotides or oligos are decoded, each oligo comprising nucleotides representing information units distributed within segment addresses and payloads, the addresses enabling to order the payloads. The addresses are extracted and the payloads are ordered in function of those addresses. The segments are further clustered into segment clusters in function of edit distances between reference addresses and the extracted addresses, each of those clusters being associated with one of the reference addresses. Cluster payloads associated respectively with at least part of the clusters are determined, and those cluster payloads are ordered in function of the reference addresses of the clusters associated with the cluster payloads.

### 1. TECHNICAL FIELD

The invention relates to the domain of nucleic acid information storage, including DNA (for deoxyribonucleic acid) and RNA (for ribonucleic acid) information storage, and is directed to decoding oligonucleotides, shortly oligos, in such nucleic acid storage.

### 2. BACKGROUND ART

Oligos are short DNA or RNA molecules made of nucleotides, the latter being organic molecules that serve as monomers of DNA or RNA. They are used to store payload data, where typically an address is used for each oligo to identify the correct order of readout oligos after sequencing, i.e. after determining the precise order of nucleotides in nucleic acid fragments.

Such a technology is described for DNA notably by G. M. Church et al. in “Next-Generation Digital Information Storage in DNA”, Science, Vol. 337, page 1628, 2012, and by N. Goldman et al. in “Towards practical, high-capacity, low maintenance information storage in synthesized DNA”, Nature, vol. 494, 2013. Since DNA has usually a significantly more stable storage form than RNA for genetic information, due to their chemical structures, DNA is generally exploited in related storage technologies. Accordingly, the current presentation will be focused on DNA. However, RNA storage is possible, too, in a similar way.

During synthesis, amplification, sequencing processes, DNA strands corresponding to oligos are subject to potential substitution, deletion and insertion errors. Nucleotides are randomly substituted with other base-pairs, or completely deleted as well as inserted into oligos at various locations.

On the other hand, multiple readout oligos associated with a same address are available. Some of the readout oligos originate from the same oligo, while different lengths other than the original oligo length are generated due to deletions and/or insertions.

Conventionally, readout oligos are clustered according to associated addresses and oligo lengths. Oligos with wrong lengths or with a wrong address are then discarded, as described in the above articles by G. M. Church et al. and by N. Goldman et al. After clustering, majority voting is carried out for each oligo cluster to determine the original payload. As shown in the previously cited articles, the number of readout oligos associated with a same address, which is called coverage, exhibits a bell-shape distribution. Therefore, some addresses have fewer readout oligos than others, or even rare readout oligos for part of them.

Consequently, after having discarded readout oligos having wrong lengths or wrong addresses, some original oligos with low coverage are not recoverable any more. In addition, due to errors in addresses, oligos associated with different addresses may be sorted in a same oligo cluster, which degrades the detection performance.

Such a situation is illustrated in an example in which oligos have been stored from encoded binary data. Since each DNA nucleotide is one out of the four DNA base nucleotides, namely Adenine (A), Cyanine (C), Guanine (G) and Thymine (T), it can be exploited for representing an information unit in base 4 through appropriate mapping, which amounts to a 2-bit information unit. This applies in a similar way to RNA storage, since each RNA nucleotide is one out of the four RNA base nucleotides, namely Guanine (G), Uracil (U), Adenine (A), Cytosine (C). The binary data encoded in base 4 can be retrieved from the oligos, further to relevant transformation.

In this respect, oligos having an address “000” and a 9-bits payload are considered (which can be obtained with m-mer oligos, m being an integer at least equal to 6). It is supposed that the five following oligos are clustered together in relation with address “000”:

oligo 1: 000 01 0001 001

oligo 2: 000 011001001

oligo 3: 000 01 0001 001

oligo 4: 000 101011110

oligo 5: 000 1 11111011

Oligos 1, 2 and 3 are generated from original oligos having the considered address “000” and oligos 4 and 5 are generated from original oligos having an address different from “000”, due to at least one alteration in the address. Also, in this example, the original payload for oligos 1, 2 and 3 is “010001001”, so that oligos 1 and 3 are error free after sequencing, while oligo 2 has one substitution error after sequencing (1 instead of 0 at the third payload position).

Then, after majority voting, the stored oligo is decided for address “000” as:

000 011001001

which differs from the original one:

000 01 0001 001

This illustrates that with current solutions, the reconstituted payloads are particularly subject to decoding errors.

### 3. SUMMARY

A purpose of the present disclosure is to improve the reliability of oligo detection in nucleic acid storage. More precisely, a potential advantage of the invention is to make it possible to detect synthesized oligos even with respect to addresses for which the average coverage is low.

A consequent possible advantage is to reduce considerably sequencing efforts, in time and/or in costs, for nucleic acid storage, notably DNA storage.

In what follows, a distinction is made in the terminology for sake of clarity, in order to distinguish the oligos as molecules possibly undergoing chemical processing on one hand, and the information and related data structures the oligos are carrying, possibly undergoing data processing, on the other hand. Each oligo (chemical aspect) is thereby associated with a data segment (information aspect).

An object of the present disclosure is notably a method for decoding data segments derived from respective stored oligos, each of those oligos comprising nucleotides representing respective information units of one of the data segments derived from that oligo. The information units are distributed within at least an address and a payload of that data segment. The addresses enable to order the payloads of the data segments.

The method comprises:
extracting the addresses of the data segments,
ordering the payloads of the data segments in function of the extracted addresses.

According to the present disclosure, the method comprises:
clustering the data segments into segment clusters in function of edit distances between reference addresses and the extracted addresses, each of the segment clusters being associated with one of the reference addresses,
determining cluster payloads associated respectively with at least part of the segment clusters,
ordering the cluster payloads in function of the reference addresses of the segment clusters associated with the cluster payloads.

Then, by contrast with the prior art practice, readout data segments having invalid addresses can still be exploited, making it possible to detect synthesized data segments even if the average coverage is low, and to enhance the reliability of payload identification for all addresses.

The ordered payloads provide decoded messages as stored in the nucleic acid information storage.

Preferably, each of the edit distances between a first of the addresses and a second of the addresses is given by a minimum number of elementary operations for transforming that first of the addresses to that second of the addresses, the elementary operations being selected between at least substitutions.

Still more advantageously, those elementary operations are selected between substitutions, deletions and insertions.

Dynamic programming can then be used to align two sequences, or equivalently, to find how to transform one sequence to the other with a minimum number of those elementary operations, also called edit operations.

In a preferred implementation, each of the addresses having a nominal number of the information units, called a nominal address length, and an effective number of the information units, called an effective address length, the clustering takes account of at least part of the data segments having effective address lengths distinct from nominal address lengths.

In this way, even addresses shorter or longer than the expected nominal address length (e.g. 3 in the above example) can be considered.

Also, the data segments having a nominal number of the information units, called a nominal segment length, and each of those data segments having an effective number of the information units, called an effective segment length, the method advantageously comprises, prior to clustering the data segments:
maintaining only the data segments having effective segment lengths within a predetermined range with respect to the nominal segment length.

In this way, insertion and/or deletion errors can be explicitly taken into account. Using readout data segments having wrong lengths, further to data segments having invalid addresses, makes it possible to still enhance the detection reliability, notably with respect to synthesized oligos corresponding to a low average coverage.

In a variant execution mode, only data segments having the correct (i.e. nominal) segment length are kept for exploitation. In still another variant execution mode, only data segments having the correct (i.e. nominal) payload length are kept for exploitation—in which case, the effective address length may be distinct from the nominal address length.

In a particular implementation, the method comprises:
clustering the data segments into the segment clusters by matching the extracted addresses with matching addresses belonging to address clusters, each of the address clusters including one of the reference addresses.

Those address clusters are preferably in the form of a look-up table, and a same invalid address may be assigned to two or more address clusters.

According to an advantageous execution mode, at least one of the data segments is assigned to at least two of the segment clusters in function of the edit distances between the reference addresses and the extracted addresses.

Namely, a given data segment may appear in two or more segment clusters.

Advantageously, the method comprises:
determining at least one of the cluster payloads by a majority voting applied to the information units of the segment cluster associated with that at least one cluster payload.

If the payload of the considered data segment has a correct length (same effective length as the nominal length), this can be made simply information unit by information unit. Otherwise, a preliminary payload size adjustment can be effected, based e.g. on correlations with the other data segments of the same segment clusters.

The processing applied to respective information units associated with nucleotides can be understood as possibly applying to sub-entities of the information units, consisting in binary units.

Preferably, the method comprises:
in determining the cluster payloads, purifying at least one of the segment clusters by eliminating at least one of the data segments from that/those segment cluster(s) based on an edit distance between that at least one data segment and the other data segments of that/those segment cluster(s).

Such a purification enables to eliminate abnormal data segments out of the cluster, notably when data segments having wrong lengths are kept. After purification, each segment cluster has data segments with a unique valid address and data segments with invalid addresses, while data segments within each cluster have limited edit distances to each other.

The method then preferably comprises:
determining the cluster payload of the at least one of the segment clusters by a majority voting applied to the information units of that/those segment cluster(s) remaining after purifying that/those segment cluster(s).

The disclosure further pertains to a device for decoding data segments derived from respective stored oligos, each of those oligos comprising nucleotides representing respective information units of one of the data segments derived from that oligo. The information units re distributed within an address and a payload of that data segment. Those addresses enable to order the payloads of the data segments.

The device comprises at least one processor configured for:
extracting the addresses of the data segments,
ordering the payloads of the data segments in function of the extracted addresses.

According to the disclosure, the at least one processor is further configured for:
clustering the data segments into segment clusters in function of edit distances between reference addresses and the extracted addresses, each of the segment clusters being associated with one of the reference addresses,
determining cluster payloads associated respectively with at least part of the segment clusters,
ordering the cluster payloads in function of the reference addresses of the segment clusters associated with the cluster payloads.

In particular embodiments, the at least one processor is configured for executing a method according to any of the above execution modes.

The device for decoding data segments preferably comprises:
at least one input adapted to receive the data segments to be decoded;
at least one output adapted to output the ordered payloads of the least part of the data segments.

A further object of the present disclosure is a device for decoding data segments derived from respective stored oligos, comprising means for executing the steps of the method for decoding data segments according to any of the above execution modes.

A further object of the present disclosure is a nucleic acid sequencer, which comprises a device according to any of the above implementations.

In addition, the disclosure pertains to a computer program for decoding data segments derived from respective stored oligos in nucleic acid storage, comprising software code adapted to perform a method compliant with any of the above execution modes when the program is executed by a processor.

The present disclosure further pertains to a non-transitory program storage device, readable by a computer, tangibly embodying a program of instructions executable by the computer to perform a method for decoding data segments derived from respective stored oligos compliant with the present disclosure.

Such a non-transitory program storage device can be, without limitation, an electronic, magnetic, optical, electromagnetic, infrared, or semiconductor device, or any suitable combination of the foregoing. It is to be appreciated that the following, while providing more specific examples, is merely an illustrative and not exhaustive listing as readily appreciated by one of ordinary skill in the art: a portable computer diskette, a hard disk, a ROM (read-only memory), an EPROM (Erasable Programmable ROM) or a Flash memory, a portable CD-ROM (Compact-Disc ROM).

### 4. LIST OF FIGURES

The present disclosure will be better understood, and other specific features and advantages will emerge upon reading the following description of particular and non-restrictive illustrative embodiments, the description making reference to the annexed drawings wherein:

FIG. 1 is a block diagram representing schematically a device for decoding data segments derived from oligos in a nucleic acid storage, compliant with the present disclosure;

FIG. 2 illustrates data segment structure used for nucleic acid storage associated with N distinct data segments;

FIG. 3 is a flow chart showing successive data segment decoding steps executed with the device of FIG. 1;

FIG. 4 details the assignment of a read-out data segment to a segment cluster in the flow chart of FIG. 3;

FIG. 5 details segment cluster purification in the flow chart of FIG. 3;

FIG. 6 diagrammatically shows a nucleic acid sequencer comprising the device represented on FIG. 1.

### 5. DETAILED DESCRIPTION OF EMBODIMENTS

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, and the like represent various processes which may be substantially represented in computer readable media and so executed by a computer or processor, whether or not such computer or processor is explicitly shown.

The terms “adapted” and “configured” are used in the present disclosure as broadly encompassing initial configuration, later adaptation or complementation of the present device, or any combination thereof alike, whether effected through material or software means (including firmware).

The functions of the various elements shown in the figures may be provided through the use of dedicated hardware as well as hardware capable of executing software in association with appropriate software. When provided by a processor, the functions may be provided by a single dedicated processor, a single shared processor, or a plurality of individual processors, some of which may be shared. Moreover, explicit use of the term “processor” should not be construed to refer exclusively to hardware capable of executing software, and refers in a general way to a processing device, which can for example include a computer, a microprocessor, an integrated circuit, or a programmable logic device (PLD). Additionally, the instructions and/or data enabling to perform associated and/or resulting functionalities may be stored on any processor-readable medium such as, e.g., an integrated circuit, a hard disk, a CD (Compact Disc), an optical disc such as a DVD (Digital Versatile Disc), a RAM (Random-Access Memory) or a ROM memory. Those instructions and/or data may then be considered as being part of the “processor”. Instructions may be notably stored in hardware, software, firmware or in any combination thereof.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces.

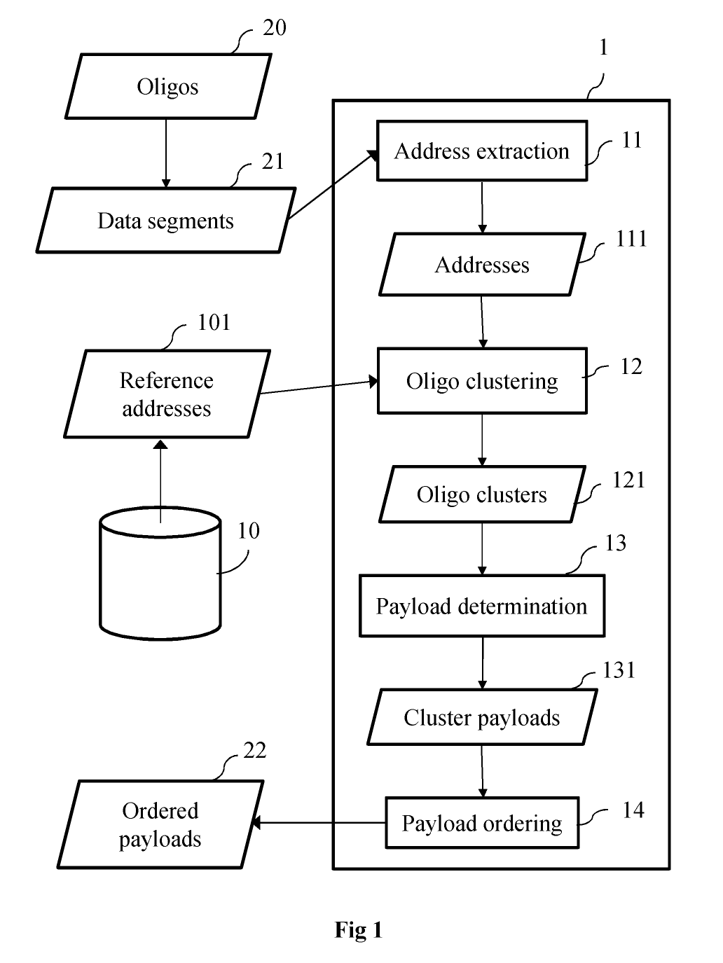

The present disclosure will be described in reference to a particular functional embodiment of device 1 for decoding data segments 21 derived from respective oligos 20 stored in a nucleic acid storage, as illustrated on FIG. 1. Obtaining the data segments 21 from the stored oligos 20 can be carried out in any sequencing manner well known to a skilled person.

The device 1 is advantageously relevant to DNA, though possibly being alternatively or cumulatively relevant to RNA. Such data segments 21 comprise nucleotides representing respective information units. Typically for DNA, each of those nucleotides is one out of the four DNA base nucleotides, namely Adenine (A), Cyanine (C), Guanine (G) and Thymine (T), and can thus be considered as representing a 2-bit information unit, i.e. a quaternary digit.

In variants, another coding model is adopted for mapping binary digits to the oligo nucleotides. In particular, the binary data are then advantageously encoded in base 3 instead of base 4, as described e.g. by N. Goldman et al. in “Towards practical, high-capacity, low-maintenance information storage in synthesized DNA”, Nature, 494; 77-80, 2013. In the latter implementation, each ternary digit maps to a DNA nucleotide on the ground of a rotating code. This avoids repeating the same nucleotide twice, and thereby the presence of homopolymers that constitute a significant factor of sequencing errors.

In the examples detailed below, the presentation is focused on DNA decoding. It will be apparent to the skilled person that similar operations work as well for RNA decoding.

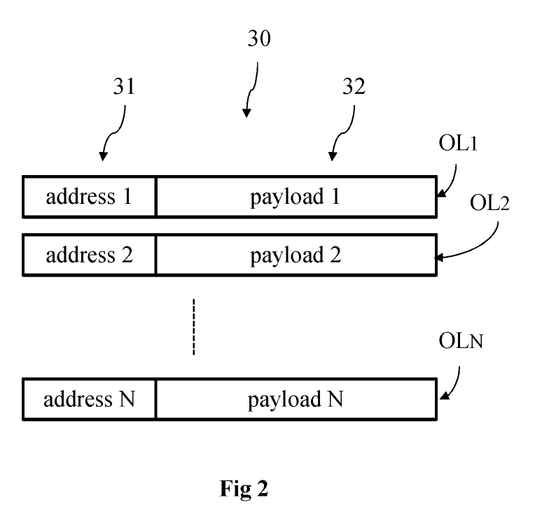

The data segments 21 are derived from N distinct reference data segments 30 as originally stored (N being a natural number), the structure of which is represented on FIG. 2. Each of those reference data segments 30, noted respectively OL₁, OL₂ . . . OL_{N} (in relation to the corresponding oligos) comprises an address 31 and a payload 32. The number N thereby refers to the number of addresses actually used when originally storing oligos—for simplicity, it is assumed below that the addresses 31 are following each other continuously from data segments OL₁ to OL_{N}.

Preferably, the address has a predetermined length identical for all segment addresses, called a nominal address length, and the payload has a predetermined length identical for all segment payloads, called a nominal payload length. Accordingly, the reference data segments have then a nominal segment length that is the sum of the nominal address length and payload length.

In variant embodiments, each data segment is considered as including at least one sub-segment derived from at least one respective primer target part. The latter is relevant to cooperation with primers—the latter being specific sequences or series of nucleotides enabling to process oligos biochemically, for instance to replicate them (e.g. by Polymerase Chain Reaction). In this case, at least one nominal primer length is possibly added to the sum of the nominal address length and payload length. In what follows, the presence of the primer target parts will be disregarded, their possible consideration in the developed implementations being straightforward for a skilled person, and possibly turned down when deriving the data segments from the sequenced oligos.

Also, in other implementations (possibly combined with the previous ones), at least two distinct predetermined payload lengths are defined, such that the nominal payload length of each data segment depends on a set of items to which it belongs. The nominal payload length is then preferably indicated in a preliminary part of the segment payload. In another advantageous mode, the lengths of the payloads are already known for the various segment addresses, and available e.g. in an external database exploited in retrieving oligo information.

In other variant embodiments (possibly combined with the previous ones), an initial part of the data segments is carrying metadata information, thereby constituting a preamble preceding the address. Such a preamble may then include the address length and/or the payload length together with the segment length, which enables more flexibility in the sizes of the data segments, and of their related address and payload. A drawback of those embodiments is however the risk of retrieving erroneous lengths, which may significantly impact following operations. Consequently, specific robustness solutions are required (which may include error correction codes and/or length checking with respect to preamble). If present in the data segments, the preamble has itself a nominal preamble length making up part of the nominal segment length.

Another potential part of the data segments is made of Error Correction Codes, which enable to decrease the levels of errors in the reconstituted information subject to additional storage and computation costs.

During synthesis, amplification, and sequencing processes, DNA strands corresponding to oligos are subject to possible substitution, deletion and insertion errors. Nucleotides are randomly substituted with other base-pairs, or completely deleted as well as inserted into oligos at various locations. On the other hand, multiple readout oligos associated with a same address are available. Some of the readout oligos originate from the same oligo, while different lengths other than the original oligo length are generated due to deletions and/or insertions. The considered data segments 21 derived from oligos 20 thus differ from the reference data segments 30 in various aspects.

The device 1 is advantageously an apparatus, or a physical part of an apparatus, designed, configured and/or adapted for performing the mentioned functions and producing the mentioned effects or results. In alternative implementations, the device 1 is embodied as a set of apparatus or physical parts of apparatus, whether grouped in a same machine or in different, possibly remote, machines.

In what follows, the modules are to be understood as functional entities rather than material, physically distinct, components. They can consequently be embodied either as grouped together in a same tangible and concrete component, or distributed into several such components. Also, each of those modules is possibly itself shared between at least two physical components. In addition, the modules are implemented in hardware, software, firmware, or any mixed form thereof as well. They are preferably embodied within at least one processor of the device 1.

The device 1 comprises a module 11 for extracting addresses 111 from data segments 21, a module 12 for clustering data segments into segment clusters 121, a module 13 for determining cluster payloads 131 corresponding to those clusters 121, and a module 14 for ordering the cluster payloads 131 into ordered payloads 22, which provide decoded information.

The clustering of data segments is based on edit distances between reference addresses 101 corresponding to the addresses 31 of the original reference data segments OL₁, OL₂ . . . OL_{N}, and the extracted addresses 111. The reference addresses 101 are preferably available from a database 10, advantageously in the form of a look-up table.

The database 10 can be available from storage resources available from any kind of appropriate storage means, which can be notably a RAM or an EEPROM (Electrically-Erasable Programmable Read-Only Memory) such as a Flash memory, possibly within an SSD (Solid-State Disk).

The edit distances can be determined in various ways relevant to syntax processes. In particular, it can be referred to the articles by G. Navarro: “A guided tour to approximate string matching”, ACM Computing Surveys, 33 (1), 31-88, 2001, and by K. U. Shulz and M. Stoyan, “Fast string correction with Levenshtein automata”, International Journal of Document Analysis and Recognition, 5 (1), 67-85, 2002.

Particular implementations are developed below.

In the presence of substitutions, deletions and insertions, dynamic programming is used to align two sequences, or equivalently, to find how to transform one sequence to the other with a minimum number of substitution, deletion and insertion operations, also known as edit operations.

For example, considering a reference sequence a=(a₁,a₂, . . . , aₙ) and a test sequence b=(b₁,b₂, . . . , bₙ), it is assumed that b is obtained from a via substitution, deletion and insertion operations. To find the minimum number of such operations, a distance matrix having dimensions (m+1)×(n+1) is constructed, where entries {d(i,j), 0≤i≤m, 0≤j≤n} in the distance matrix denote the minimum edit distance for the transform from (a₁,a2, . . . , aᵢ) to (b₁,b₂, . . . , bⱼ), with d(0,j)=d(i,0)=0, for 0≤i≤m, 0≤j≤n.

The distance d(i,j) is then calculated recursively as follows:

d(i,j)=min{d(i,j−1)+1,d(i−1,j)+1,d(i−1,j−1)+cost(aᵢ,bⱼ)}

where the distance increase due to an insertion (transformation of a(i−1) from b₍ⱼ₋₁₎ to bⱼ) or a deletion (transformation of ai from bj to b₍ⱼ₋₁₎) is 1 and the distance increase due to substitution is cost(aᵢ,bⱼ). That distance increase can be chosen as:

cost(aᵢ,bᵢ)=0 if aᵢ is equal to bⱼ

cost(aᵢ,bⱼ)=1 if aᵢ differs from bⱼ

This example illustrates the principle of dynamic programming, while the distance increases may be defined differently for insertion, deletion or substitution errors, depending on application cases.

At the end of the recursions, the minimum edit distance between a and b is determined as d(m,n). This value is shortly said to constitute the “edit distance between a and b”.

For example, a sequence b=(0,0) can be obtained by a series of copy, substitution, deletion from another sequence a=(0,1,1). The edit distance between (0,0) and (0,1,1) is d(a,b)=2.

In variant implementations, transpositions (switching two successive characters) are also considered as edit operations further to the previous ones.

The clustering module 12 is adapted to proceed as follows when N′>N addresses are retrieved from the data segments 21 by the extracting module 11. First a look-up table for N address clusters is constructed. This is accomplished in two steps:
assigning the N valid reference addresses 31 to N clusters;
comparing each of the (N′-N) invalid addresses with individual valid addresses, and if their edit distance is equal to or lower than a threshold thₐ, assigning the invalid address to the address cluster associated with the valid address.

The threshold thₐ is for example an integer comprised between 1 and 5 (included), and advantageously equal to 2 or 3.

For example, 3 bits are used in data segments for address, and only 4 addresses are used for identifying data segments, namely {000, 001, 010, 011}. Accordingly, {100, 101, 110, 111} are invalid addresses. If we set thₐ=1, a look-up table is obtained for four address clusters as:
{000, 100}, {001, 101}, {010, 110}, {011, 111}.
   where there is one valid address in each address cluster. Those four address clusters are then employed to cluster data segments after sequencing, by identifying the corresponding address cluster for a segment address. It can be noted that each invalid address may be assigned to multiple clusters.

The clustering module 12 is further adapted to sort data segments into N segment clusters according to the look-up table for address clusters. Specifically, if the address of a readout data segment belongs to the i-th address cluster, the readout data segment is assigned to the i-th segment cluster—a readout data segment possibly appearing in multiple segment clusters.

When assigning a current read-out data segment to one of the segment clusters 121, a preliminary stage is preferably executed for checking whether that data segment has an effective length that is much lower or much higher than the nominal segment length. If it is the case, that data segment has gone through too many substitution, insertion or deletion errors after sequencing. Accordingly, the data segment is discarded from further processing.

A filtering length range is advantageously exploited upstream by the clustering module 12 for selecting the read-out data segments kept for decoding. In particular embodiments, that length range is defined with respect to the nominal segment length, by adding an excess tolerance offset and removing a default tolerance offset—the excess and default tolerance offsets being advantageously identical. For example, a segment length range can be defined as [nominal segment length−2, nominal segment length+2], all data segments having lengths out of this length range being discarded.

As mentioned above, depending on the implementations, the nominal segment length is the same for all data segments, or may depend on a category to which the data segment belongs. Also, in variants, the payload length is tested instead of the segment length. In that case, a nominal payload length is considered for testing.

If the length of a data segment lies in the length range, the address of the data segment is used to identify to which segment cluster 121 this data segment belongs, according to the previously constructed address cluster look-up table. Thereafter, that data segment is assigned to the corresponding segment cluster.

The module 13 for determining the cluster payloads 131 is adapted to purify the N segment clusters 121 obtained from the clustering module 12. The coverage of each of those clusters 121, i.e. the number of data segments with correct length in that cluster, is considered as a criterion to perform a cluster purification or not for that cluster. If the coverage is sufficiently high, a simple majority voting is used for correct detection of the original synthesized oligo corresponding to the data segments 30. Preferably, a coverage threshold th_{c} is exploited in this respect.

The threshold th_{c} is e.g. comprised (including the bounds) between 10 and 100, and preferably between 10 and 20. In variants, it is comprised between 3 and 10, and preferably between 4 and 6.

Otherwise, a cluster purification is executed by evaluating an edit distance matrix for the concerned cluster 121. Namely, if a data segment in the cluster has large edit distances to other data segments in that cluster, it is eliminated from the cluster.

The edit distances are preferably determined in the same way as for the edit distances between addresses described above. In a variant implementation, the evaluation is effected on the segment payloads, instead of the whole data segments.

In a generalized implementation, cluster purification divides elements in the cluster into sub-clusters and abnormal data segments. The latter have large edit distances to other data segments, while data segments within each sub-cluster have small edit distances between each other, and two data segments from two different sub-clusters have large edit distances. If there are more than one sub-clusters, only the sub-cluster having the highest number of data segments is maintained, and all other data segments are eliminated from the considered cluster.

The terms “large” and “small” are advantageously interpreted as having autonomous absolute meanings, e.g. at most one unit (or two units) for “small” and at least four units (or five or six units) for “large”. In variant embodiments, the terms “large” and “small” are relative with respect to one another. For example, an edit distance can be considered as “large” if it is worth at least three units (or four units, or five units) above any “small” edit distance (i.e. the largest of them).

After such a cluster purification, segment detection can be carried out for that cluster based on e.g. majority voting if the coverage is high enough, or on a dynamic-programming for clusters otherwise. In the latter case, a combination of the data segments available in the cluster 121 is advantageously exploited for reconstituting the correct information units. Such a technique is disclosed notably in the European patent application dated 30 Oct. 2015 by the same Applicant, no 15306731.9 (Xiaoming Chen et al.).

The majority voting is preferably applied to each successive information unit.

The cluster purification is illustrated on the above example with five data segments derived from five respective oligos, for which existing methods failed:

oligo 1: 000 01 0001 001

oligo 2: 000 011001001

oligo 3: 000 01 0001 001

oligo 4: 000 101011110

oligo 5: 000 1 11111011

A related edit distance matrix is obtained, as shown in Table 1. It is symmetric, so that only upper diagonal entries of that matrix need to be evaluated.

TABLE 1
Edit distance matrix for five data segments
within a same segment cluster

| Edit distance | Oligo 1 | Oligo 2 | Oligo 3 | Oligo 4 | Oligo 5 |
|---|---|---|---|---|---|
| Oligo 1 | 0 | 1 | 0 | 5 | 4 |
| Oligo 2 | 1 | 0 | 1 | 6 | 3 |
| Oligo 3 | 0 | 1 | 0 | 5 | 4 |
| Oligo 4 | 5 | 6 | 5 | 0 | 3 |
| Oligo 5 | 4 | 3 | 4 | 3 | 0 |

It can be observed that the data segments derived from oligo 4 and oligo 5 have large edit distances to all other data segments. Consequently, the data segments derived from oligos 4 and 5 are eliminated from the segment cluster. After cluster purification, the remaining data segments in the cluster have low edit distances to each other:

{000 010001001, 000 011001001, 000 010001001}

By means of majority voting, the originally synthesized data segment (000 010001001) is correctly recovered.

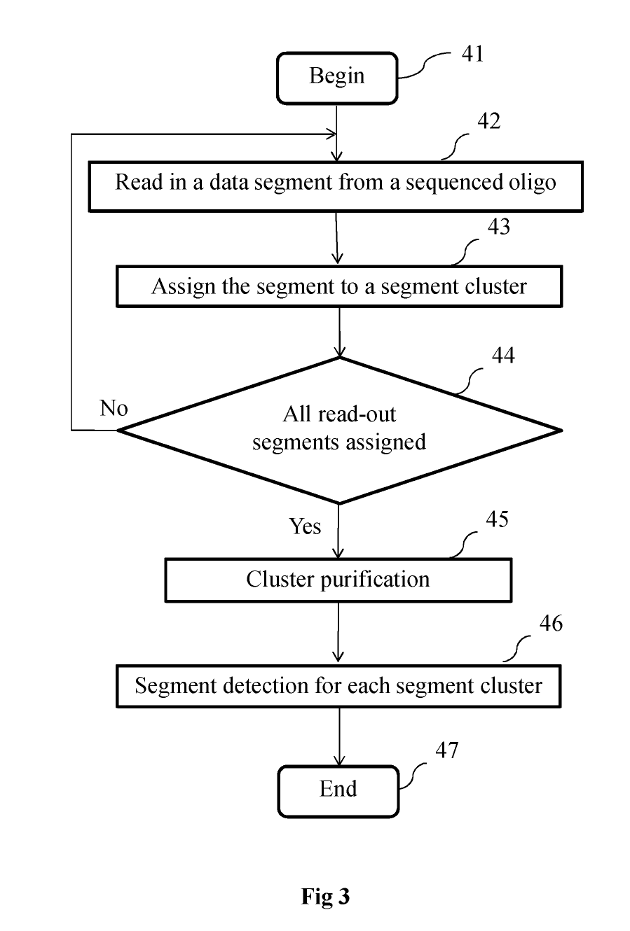

In execution, as illustrated on FIG. 3, the device 1 proceeds preferably as follows in a decoding operation. Further to a beginning step 41, a data segment derived from a sequenced oligo is read at step 42 (module 11), while being advantageously transformed to an expression with binary data. The data segment is assigned to a segment cluster at step 43 (module 12). Subject to testing at step 44 whether all read-out data segments are assigned, the reading and clustering operations are repeated. When the cluster assignment is completed, a cluster purification step 45 is performed, followed by segment detection for each segment cluster at step 46 (module 13). This finalizes the segment detection process (end step 47), which enables the global decoding based on payload ordering (module 14).

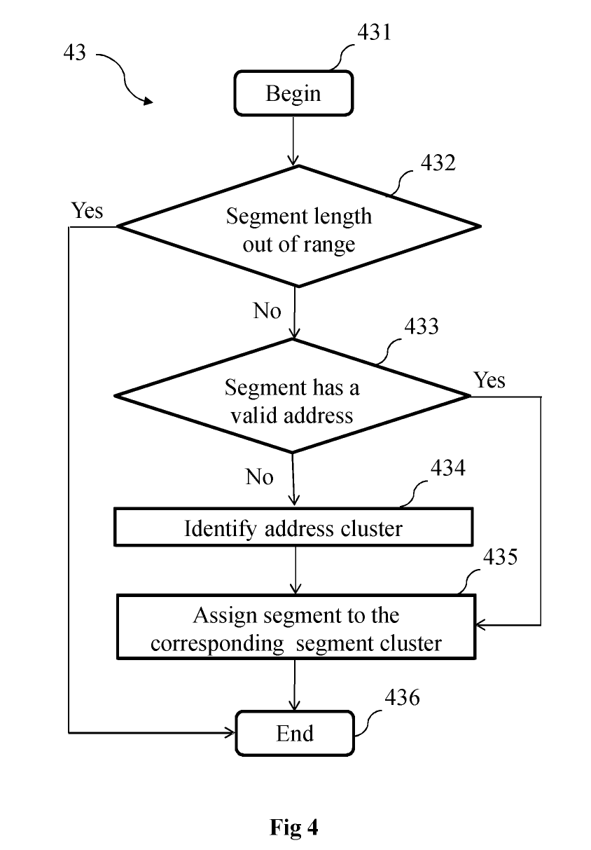

More in detail regarding the clustering step 43, as developed on FIG. 4, once the assignment operations are launched for a given read-out data segment (begin step 431), it is tested at step 432 whether the segment length is out of range. If yes, the data segment is discarded (end step 436). Otherwise, it is tested at step 433 whether the data segment has a valid address. If yes, the data segment is directly assigned to the corresponding segment cluster at step 435. Otherwise, the corresponding address cluster is identified at step 434 based on edit distances between the related address and the reference addresses, which is preferably carried out by means of a look-up table for address clusters, as previously explained. The data segment is then assigned to the corresponding segment cluster at step 435. The clustering operation is finalized at end step 436 further to that assignment.

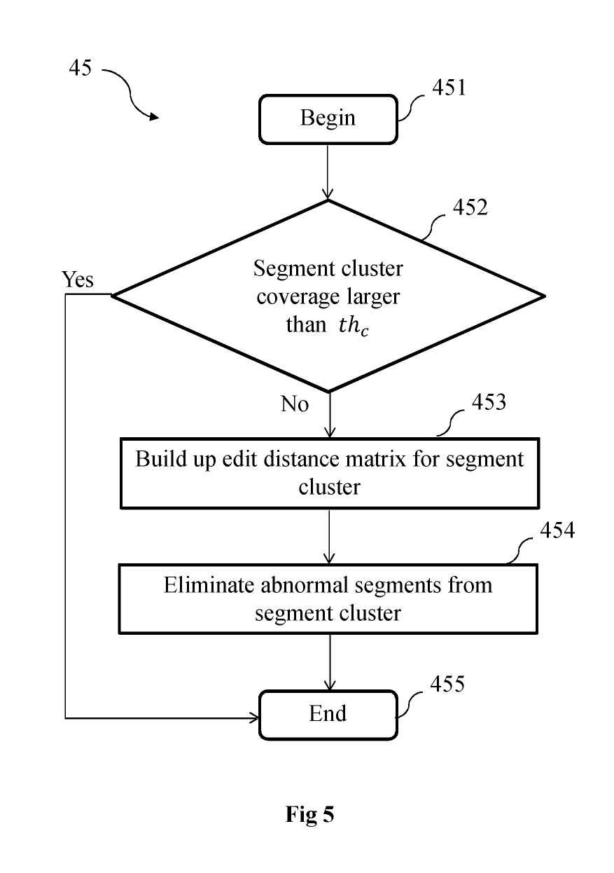

More in detail regarding the purification step 45, as developed on FIG. 5, once the purification operations are launched for a given segment cluster (begin step 451), it is tested at step 452 whether the segment cluster coverage is larger than a threshold th_{c}. If yes, the purification process is turned down (end step 455). Otherwise, an edit distance matrix is built up for the current segment cluster at step 453, and abnormal data segments are eliminated from that segment cluster at step 454. The purification operation is finalized at end step 455 further to those eliminations.

In summary, in advantageous execution modes:
data segments having a length within a certain range are maintained, explicitly taking insertions and/or deletion errors into account,
data segments are clustered according to a look-up table for address clusters, which tolerates substitution, insertion, deletion errors in address to some extent,
each segment cluster is purified if necessary to eliminate abnormal data segments out of the cluster; after purification, each segment cluster has data segments with a unique valid address and data segments with invalid addresses, while data segments within each cluster have limited edit distances to each other.

Using readout data segments with wrong lengths and/or invalid addresses makes it possible to detect synthesized oligos even if the average coverage is low. Segment cluster purification makes oligo detection more reliable than conventional approaches. Consequently, sequencing effort (time and cost) for DNA storage can be considerably reduced, while having an improved reliability of DNA storage. The same applies to RNA information storage.

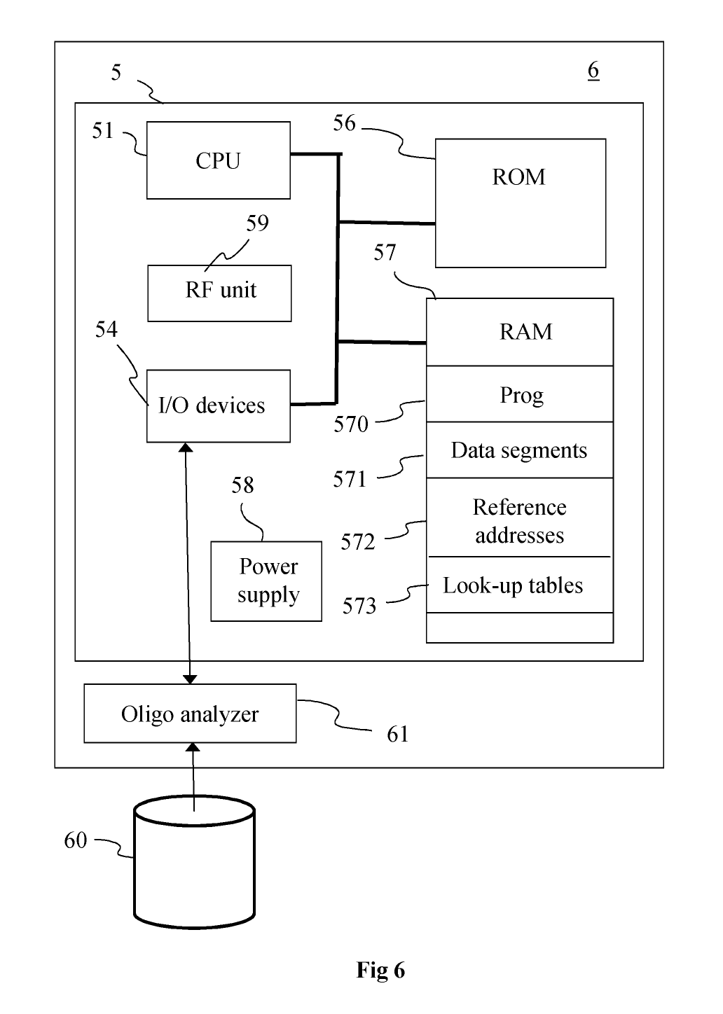

A particular apparatus 5, visible on FIG. 6, is embodying the device 1 described above. It corresponds for example to a parallel computer, a microcomputer, a laptop, or a tablet. In the represented implementation, that apparatus 5 is coupled with an oligo analyzer 61, so as to form together a DNA sequencer 6 (an RNA sequencer in a variant implementation).

The oligo analyzer 61 is configured for analyzing oligos from a DNA storage 60, e.g. by electrophoresis, methylation profiling or pyrosequencing.

The apparatus 5 comprises the following elements, connected to each other by a bus 55 of addresses and data that also transports a clock signal:
a microprocessor 51 (or CPU);
a non-volatile memory of ROM type 56;
a RAM 57;
one or several I/O (Input/Output) devices 54 such as for example a keyboard, a mouse, a joystick, a webcam; other modes for introduction of commands such as for example vocal recognition are also possible;
a power source 58; and
a radiofrequency unit 59.

It is noted that the word “register” used in the description of memories 56 and 57 can designate a memory zone of low capacity (some binary data) as well as a memory zone of large capacity (enabling a whole program to be stored or all or part of the data representative of data calculated or to be displayed).

When switched-on, the microprocessor 51 loads and executes the instructions of the program contained in the RAM 57.

The random access memory 57 comprises notably:
in a register 570, the operating program of the microprocessor 51 responsible for switching on the apparatus 5,
in a register 571, parameters representative of data segments derived from analyzed oligos;
in a register 572, parameters representative of segment reference addresses;
in a register 573, parameters representative of look-up tables for segment clusters.

According to a variant, the power supply 58 is external to the apparatus 1.

On the ground of the present disclosure and of the detailed embodiments, other implementations are possible and within the reach of a person skilled in the art without departing from the scope of the invention. Specified elements can notably be interchanged or associated in any manner remaining within the frame of the present disclosure. Also, elements of different implementations may be combined, supplemented, modified, or removed to produce other implementations. All those possibilities are contemplated by the present disclosure.

1. A method for decoding data segments derived from respective stored oligonucleotides or oligos, each of said oligos comprising nucleotides representing respective information units of one of said data segments derived from said each of said oligos, said information units being distributed within at least an address and a payload of said one of said data segments, said addresses enabling to order the payloads of said data segments,
said method comprising steps of:
extracting the addresses of said data segments,
ordering the payloads of said data segments in function of said extracted addresses,
wherein said method comprises steps of:
clustering said data segments into segment clusters in function of edit distances (d(m,n)) between reference addresses and said extracted addresses, each of said segment clusters being associated with one of said reference addresses,
determining cluster payloads associated respectively with at least part of said segment clusters,
ordering said cluster payloads in function of the reference addresses of said segment clusters associated with said cluster payloads.

2. The method according to claim 1, wherein each of said edit distances (d(m,n)) between a first of said addresses and a second of said addresses is given by a minimum number of elementary operations for transforming said first of said addresses to said second of said addresses, said elementary operations being selected between at least substitutions.

3. The method according to claim 2, wherein said elementary operations are selected between substitutions, deletions and insertions.

4. The method according to claim 1, wherein each of said addresses having a nominal number of said information units, called a nominal address length, and an effective number of said information units, called an effective address length, said clustering takes account of at least part of the data segments having effective address lengths distinct from nominal address lengths.

5. The method according to claim 1, wherein said data segments having a nominal number of said information units, called a nominal segment length, and each of said data segments having an effective number of said information units, called an effective segment length, said method comprises a step of, prior to clustering said data segments:
maintaining only said data segments having effective segment lengths within a predetermined range with respect to said nominal segment length.

6. The method according to claim 1, wherein said method comprises a step of:
clustering said data segments into said segment clusters by matching said extracted addresses with matching addresses belonging to address clusters, each of said address clusters including one of said reference addresses.

7. The method according to claim 1, wherein at least one of said data segments is assigned to at least two of said segment clusters in function of said edit distances (d(m,n)) between said reference addresses and said extracted addresses.

8. The method according to claim 1, wherein said method comprises a step of:
determining at least one of said segment payloads by a majority voting applied to the information units of the segment cluster associated with said at least one of said cluster payloads.

9. The method according to claim 1, characterized in that said method comprises:
in determining said segment payloads, purifying at least one of said segment clusters by eliminating at least one of said data segments from said at least one of said segment clusters based on an edit distance (d(m,n)) between said at least one of said data segments and the other data segments of said at least one of said segment clusters.

10. The method according to claim 9, wherein said method comprises a step of:
determining the cluster payload of said at least one of said segment clusters by a majority voting applied to the information units of said at least one of said segment clusters remaining after purifying said at least one of said segment clusters.

11. A device for decoding data segments derived from respective stored oligonucleotides or oligos, each of said oligos comprising nucleotides representing respective information units of one of said data segments derived from said each of said oligos, said information units being distributed within at least an addresses and a payload of said one of said data segments, said addresses enabling to order the payloads of said data segments,
said device comprising at least one processor configured for:
extracting the addresses of said data segments,
ordering the payloads of said data segments in function of said extracted addresses,
wherein said at least one processor is further configured for:
clustering said data segments into segment clusters in function of edit distances (d(m,n)) between reference addresses and said extracted addresses, each of said segment clusters being associated with one of said reference addresses,
determining cluster payloads associated respectively with at least part of said segment clusters,
ordering said cluster payloads in function of the reference addresses of said segment clusters associated with said cluster payloads.

12. The device according to claim 11, wherein said at least one processor is configured for executing a method according to any of claims 1 to 10.

13. The device according to claim 11, wherein said device comprises:
at least one input adapted to receive said data segments to be decoded;
at least one output adapted to output said ordered payloads of said least part of said data segments.

14. The device according to claim 11, wherein the device is included in a nucleic acid sequencer.

15. A non-transitory computer readable medium that includes, software code executable by a processor, the software code for decoding data segments derived from respective stored oligonucleotides or oligos, the software code adapted to perform a method comprising:
extracting, the addresses of said data segments,
ordering the payloads of said data segments in function of said extracted addresses,
characterized in that said method comprises:
clustering said data segments into segment clusters in function of edit distances (d(m,n)) between reference addresses and said extracted addresses, each of said segment clusters being associated with one of said reference addresses,
determining cluster payloads associated respectively with at least part of said segment clusters,
ordering said cluster payloads in function of the reference addresses of said segment clusters associated with said cluster payloads.
